(19) United States
(12) Patent Application Publication
(10) Pub. No.: US 2005/0103961 A1
(43) Pub. Date: May 19, 2005

(54) Sheet metal cable hook

(76) Inventors: Kenneth A. Swanstrom, Doylestown, PA (US); Joseph E. McKenna, North Wales, PA (US); Brian G. Bentrim, Hatfield, PA (US)

Correspondence Address: GREGORY J. GORE, 70 WEST OAKLAND AVENUE, SUITE 316, DOYLESTOWN, PA, 18901, US

(21) Appl. No.: 10/506,996

(22) PCT Filed: Feb. 13, 2003
(86) PCT No.: PCT/US03/04200

Related U.S. Application Data
(60) Provisional application No. 60/363,250, filed on Mar. 12, 2002.

(51) Int. Cl. F16B 45/00

(52) U.S. Cl. 248/305

(57) ABSTRACT

A cable hook includes attachment means with a substantially base having a plantar bottom surface. The hook portion extends upwardly from the base (17) and includes upper and lower jaws (21, 23) with a lateral opening that is substantially circular. A single, laterally-extending notch (20) is located on the inside surface of the upper jaw proximate a frontal opening (22) between the jaws. Orientation marks (12) are included on the bottom surface of the base (17). Panel attachment means (18) are preferably deformer undercut grooves (16) for receiving the cold flow of metal from a metal panel (19) attached thereby. The hook (10) may be used to secure cables, a spring, a rod, tubing, or shaft.

The present application is related to provisional patent application Ser. No. 60/363,250 entitled “Sheet Metal Cable Hook” filed on Mar. 12, 2002, priority from which is hereby claimed.

### FIELD OF TH INVENTION

The present invention relates to self-clinching fastener that provides a permanent location for removably attaching items such as a wiring or fiber-optic bundle.

### BACKGROUND OF THE INVENTION

Electrical equipment quite often has the signal and/or power distribution wiring-bundle routed around the inside of a metal cabinet. It is important that this wiring-bundle be secured in a specific location inside the cabinet to ensure that mechanical and electrical interference concerns are properly addressed. It is further desirable to have the outside of the cabinet flush and sealed for environmental and electrical interference reasons. It is yet further desirable that the wiring-bundle can be temporarily relocated with minimal risk of damage.

The known attachment methods do not adequately address these requirements and have several shortcomings. One known attachment method is to mount an adhesive based element to a flat surface and then use this mount to secure the wiring-bundle with a permanent plastic cable-tie. However, the adhesive mount is subject to failure and high temperatures or temperature variations can cause adhesive bond to deteriorate and release. Furthermore, this attachment method does not allow for easy removal of the wiring-bundle for maintenance. Another known attachment means for mounting cables includes snapping a plastic mount through a hole in the exterior of the panel, however because this type of plastic mount protrudes through the outside of the panel it is not flush. Threaded fastening devices have been employed to mount cables, however they must be inserted from the outside of the cabinet and then through the mounting device on the inside which is often awkward and may require two people to perform. In yet another attachment method, prior art clinch fasteners have been used to provide the required smooth metallic outer surface for the cabinet, however they only provide a walled hole on the inside through which the wiring-bundle cable-tie must be passed. This permanently attaches the wiring-bundle and if the wiring-bundle needs to be temporarily repositioned the cable-tie needs to be cut, posing risk of damage to the wiring-bundle during the cutting operation and further requiring a new cable-tie for reassembly.

It is therefore an object of the present invention to provide a permanently mounted fastener that establishes a fixed location for securing a wiring-bundle while allowing for its easy removal and repositioning. It is yet another object of the present invention to provide an attachment mounting for a wire-bundle cable-tie which permits the cable-tie to be easily removed. It is another object of the present invention to provide a hook-type wire-bundle holder which prevents the inadvertent removal of the cable-tie. It is a further object of the invention to provide a panel-mounted fastener that can releaseably secure a variety of different items such as springs, rods, tubing, or shafts. It is yet a further object of the invention to provide a hook-type mounting which provides abrasion resistance and electrical insulation.

### SUMMARY OF THE INVENTION

The present invention is a metal fastener which is permanently clinched into a rectangular hole in a metallic panel such as the wall of a metal cabinet. The clinching process ensures a flush, permanent, sealed metallic outer surface which can be cosmetically finished with the same process, such as painting, used to finish the rest of the cabinet. A portion of the fastener protruding on the inner surface of the cabinet includes a hook of specific shape and size. The lateral opening of the hook allows an industry standard screw-mount cable-tie to be placed through the opening from the side.

More specifically, the applicant has invented a cable hook having a self-clinching attachment means which includes a substantially rectangular base having a planar bottom surface and further including panel attachment means located on opposing front and rear side surfaces thereof. A hook portion extends upwardly from the base, the hook portion including upper and lower jaws forming a substantially C-shaped hook with a frontal opening located between spaced ends of the jaws. The C-shaped hook has a lateral opening that is substantially circular. The cable hook further includes a single laterally extending notch on the inside surface of the upper jaw proximate the frontal opening. The jaws have a continuous arcuate inside surface except for the notch. The base includes orientation marks on the bottom planar surface thereof proximate only one of the front or rear sides. The panel attachment means are deformer undercut grooves for receiving the cold flow of metal from a panel attached thereby.

In alternate embodiments, a metal or electrically non-conductive thermoplastic insert encompasses the inside surface of the jaws and partially encompasses the lateral sides of the fastener adjacent the lateral opening, covering the edges of the jaws. A pivotable flap lies across the frontal opening to positively retain items held within the hook. The flap is unitary with the insert and resiliently biased toward a closed position.

In another embodiment, a spring-biased catch covers the frontal opening of the fastener to positively retain items held within the hook. The insert has two opposing ears which have inward-facing dimples that engage cooperating recesses on opposite sides of the lower jaw to provide a pivot for the catch. A tail portion of the insert is free to slide against the inside surface of the lower jaw to provide a spring force to close the catch.

When using the invention, the cable-tie is placed around the wiring-bundle and secured in the normal manner. If the wiring-bundle must be temporarily relocated, the cable-tie can be removed from the front of the fastener through a gap between the jaws of the hook without unbundling the wires. Re-attachment of the wiring-bundle is readily accomplished by reversing the process from the front end of the hook. No new cable-ties are required and the risk of damaging the wiring-bundle during a removal/cutting operation is eliminated. The fastener shape and opening size retain the cable-tie in many positions yet allow for its easy removal. Other objects and advantages of the present invention will be readily apparent to those of skill in the art from the following drawings and description of the preferred embodiments.

### BRIEF DESCRIPTION OF THE DRAWINGS

FIG. 1 is an isometric view of the sheet metal cable hook of the present invention.

FIG. 2 is a side view of the invention installed in a metal sheet which is shown in phantom lines.

FIG. 3 is an isometric view of the sheet metal cable hook mounted on a vertical panel shown in phantom lines with the cable-tie and wiring-bundle.

FIG. 4 is a left side isometric view of an alternate embodiment including a plastic insert.

FIG. 5 is a left side isometric view showing an alternate embodiment which utilizes a grommet-type insert.

FIG. 6 is a left side isometric view of an alternate embodiment which includes a catch covering the opening of the hook portion of the fastener.

FIG. 7 is a left side view of a second alternate embodiment incorporating a spring-biased hook covering the opening of the fastener.

### DESCRIPTION OF THE PREFERRED EMBODIMENTS

Referring to FIG. 1, the present invention 10 is a metal, self-clinching fastener. A base 17 is substantially rectangular and flat, and includes clinch features, deformer 18 and undercut 16 which are provided at opposite sides. An upper portion of the fastener includes two curved jaws 21 and 23 which form a “C”-shaped hook having a lateral opening 15 that is substantially circular. Upper jaw 21 is an arcuate hook extending from the lower portion or base 17 of the fastener which includes lower jaw 23. The upper portion, or hook, of the fastener including curved jaws 21 and 23 is of uniform, lateral thickness. A frontal opening 22 between the ends of the jaws may be sized to closely receive a cable-tie or similar structure of rectangular cross-section, sideways. The hook formed by jaws 21 and 23 has a continuous arcuate inside surface except for notch 20. Notch 20 helps to prevent unintentional removal of the cable-tie due to vibration. Orientation marks 12 on the bottom of the base 17 allow for easy identification of the cable-tie receiving end of the fastener when it is being installed from the opposite side of the attached metal sheet if the hook portion is not visible to the installer.

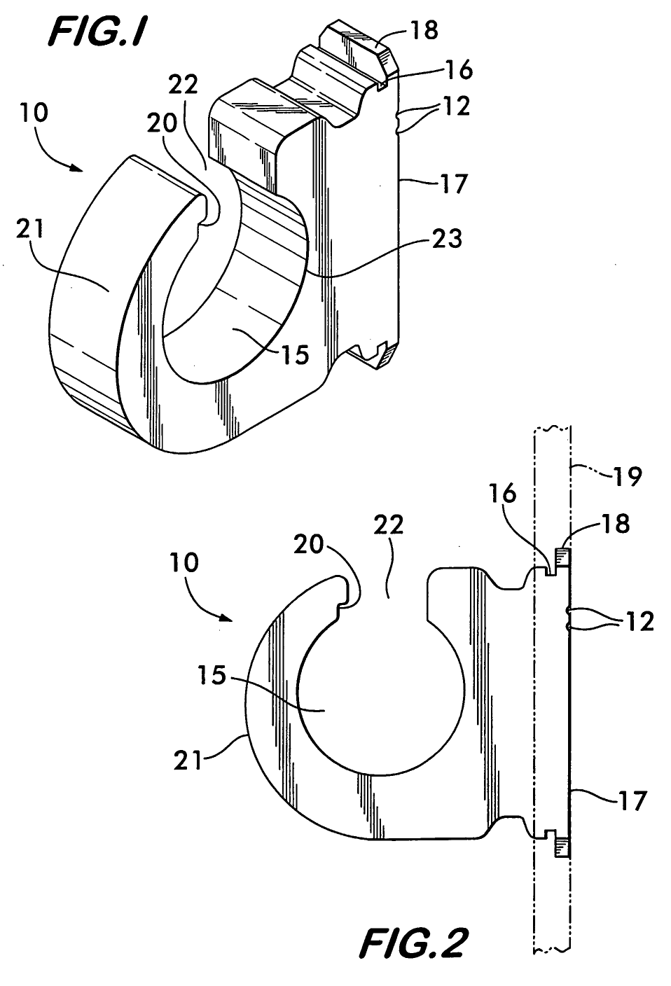

FIG. 2 shows the fastener 10 installed in a metal sheet 19. Fastener 10 is pressed into a rectangular opening in metal sheet 19 until the flat base 17 is flush with the insertion side of the sheet. When fully installed, the deformer 18 displaces a portion of the metal sheet 19 into the undercut 16 thereby embedding the clinch features and locking the fastener 10 into the sheet. The hook portion includes a lateral opening 15 and a frontal opening or mouth 22 between the jaws at the front of the fastener. Notch 20 is included on the inside of the upper jaw 21 near its end. Orientation marks 12 are positioned toward the front end of the fastener and are visible from the opposite side of the sheet to ensure that the fastener is properly oriented when installed.

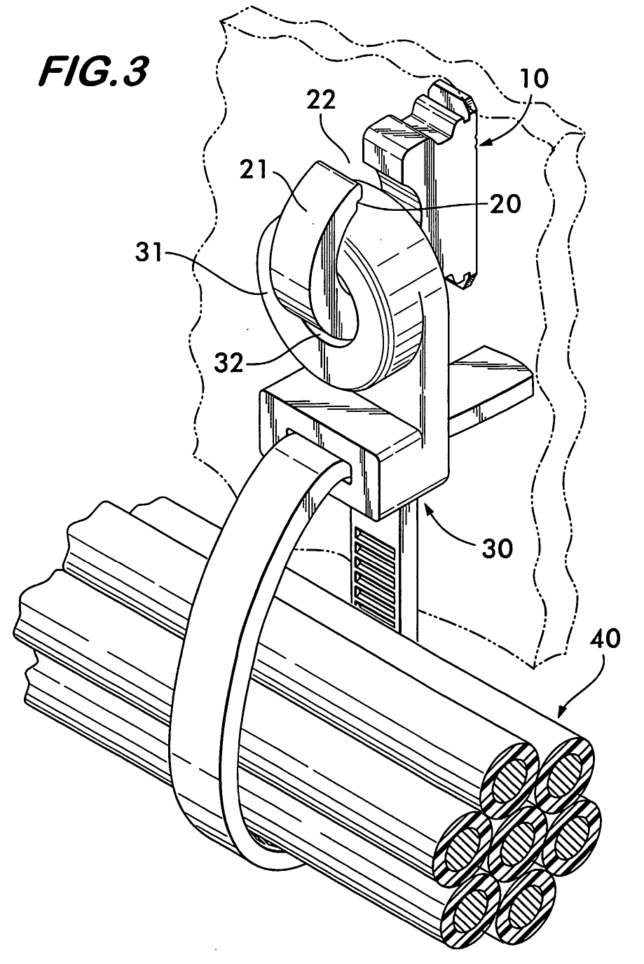

FIG. 3 shows fastener 10 in the position installed on a vertical wall in a cabinet or similar enclosure 19 with the hook opening 22 in an upward-facing position. As depicted, the cable-tie 30 has been fitted over the jaw 21 and is hanging from the fastener and wrapped around the wiring-bundle 40 in the normal manner. The cable-tie 30 shown is an industry standard version that is normally screw-mounted by a through-hole 32 in portion 31. The hook of the fastener is carefully sized so that the thickness of the screw-mounting portion 31 is greater than the dimension of opening 22. Therefore, the cable-tie through-hole must be rotated at an angle over jaw 21 of the fastener to achieve attachment. This careful sizing of the hook opening and cable-tie thickness ensures that the cable-tie will not readily separate from the fastener during normal use because a compound motion is required to remove it from between the jaws of the hook. Once received, the structure is permitted some degree of movement within the hook opening but it is not easily removed between the jaws.

The embodiment shown in FIGS. 1-3 typifies the simplest version of the present invention which, as it will be understood by those of skill in art, may be used for many different applications and oriented in different ways. For example, the fastener may be applied to either horizontal or vertical surfaces. In the case of attachment to a vertical surface, the opening of the hook may face downward while still retaining the cable-tie. Furthermore, it may be used to attach many other items such as a spring, a rod, tubing, or a shaft. The uses of the invention are limited only by the imagination of one employing the device.

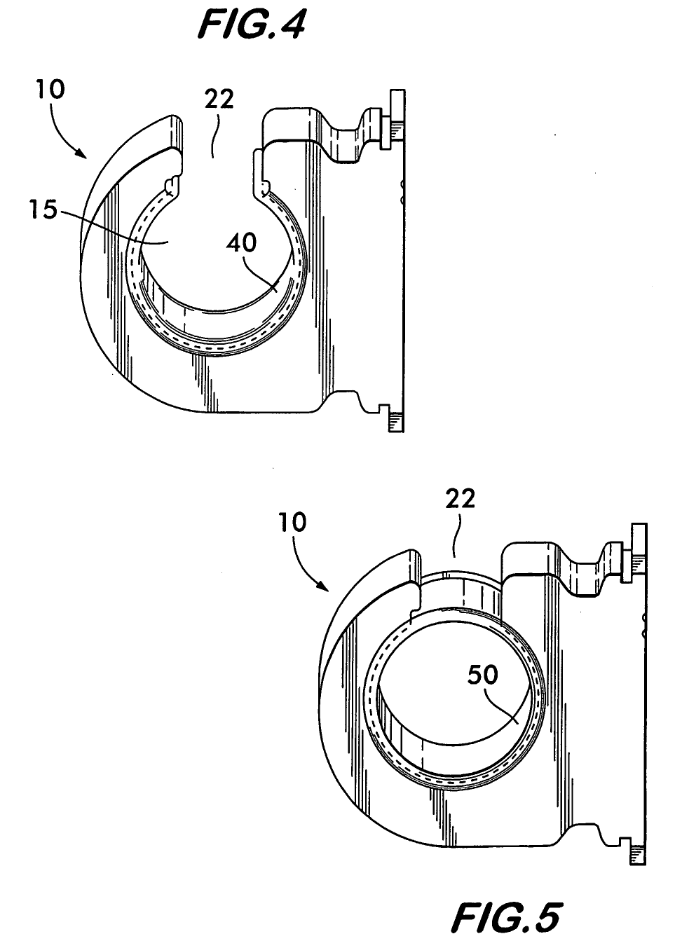

FIGS. 4-7 depict alternate embodiments of the invention. FIG. 4 shows an isometric and side view of fastener 10 with an added plastic insert 40 encompassing the inside surface of the jaws. The plastic insert wraps around the lateral sides of the fastener adjacent opening 15 to provide abrasion resistance and electrical insulation between an item that is inserted through the opening and the fastener jaws while the opening 22 remains unobstructed.

FIG. 5 shows an isometric and side view of fastener 10 with a thermoplastic insert or grommet 50 covering the fastener opening and the edges of the jaws around it. The grommet 50 is tubular and closes opening 22.

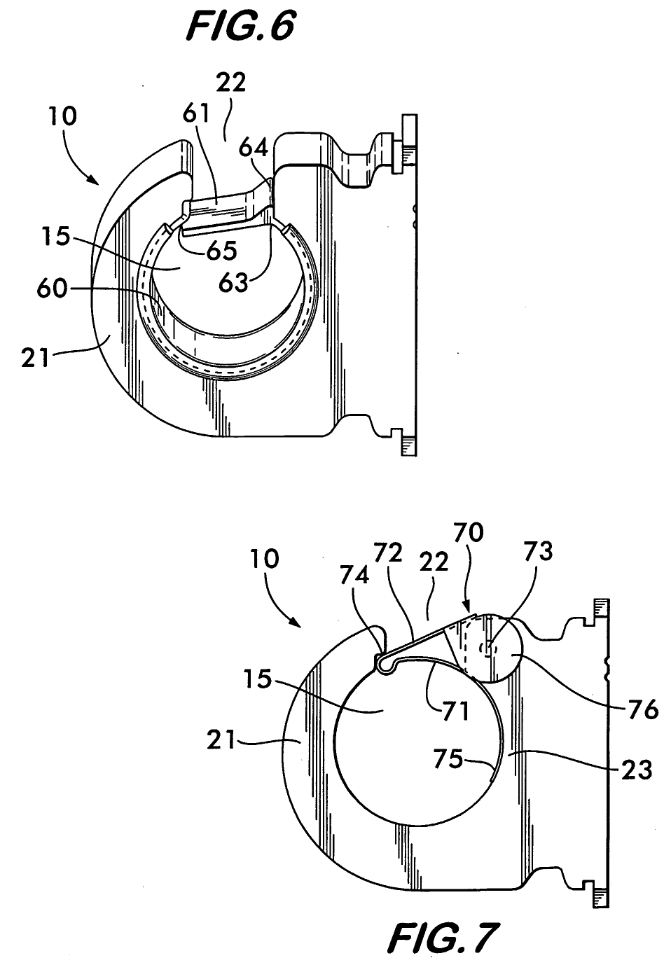

FIG. 6 shows fastener 10 further including a flexible plastic insert 60. Flap 61 of plastic insert 60 covers the frontal opening 22 of fastener 10 and pivots at point 63 while biased to contact the upper jaw 21 at point 65 due to its shape memory. Feature 64 of the plastic insert serves two functions, it provides a stop for the motion of flap 61 in the closing direction and it also keeps the plastic insert from rotating around lateral opening 15. The plastic insert 60 also serves to cover the metal surfaces around the lateral opening 15 for abrasion resistance and electrical insulation. In this way, a clip is formed to positively retain an item such as a cable-tie loop which passes through the lateral hook opening. Items retained by the hook may be released by depressing the flap in the usual way.

FIG. 7 shows a side view of fastener 10 including a formed metal insert 70. The insert provides a spring-biased catch 72 covering the opening 22 at the front of the fastener so that the hook portion, as in the previous embodiment, forms a spring clip and items inserted through the opening of the hook may not be removed from the front without assistance. The insert 70 is pivoted at point 73 and is biased against the upper jaw 21 at point 74. The metal insert includes two opposing ears 76 which have inward-facing dimples that cooperate with like dimensioned recesses on opposite sides of the lower jaw 23 to achieve the pivot point 73. This combination of mechanical structures holds the insert laterally and provides a snap-fit attachment of the insert to the hook. The closing force is provided by spring portion 71 that includes a tail 75 which is free to slide against the inside surface of the lower jaw 23. Items which pass through the hook opening may only be removed from the opening of the hook after the catch has been depressed as required in the usual clip attachment/release fashion. The insert 70 may also be formed of plastic.

It should be understood that there may be other modifications and changes to the present invention that will be obvious to those of skill in the art from the foregoing description, however, the present invention should be limited only by the following claims and their legal equivalents.

1. A cable hook having self-clinching attachment means, comprising:
a substantially rectangular base having a planar bottom surface and further including panel attachment means located on opposing front and rear side surfaces thereof;
a hook portion extending upwardly from said base, said hook portion including upper and lower jaws forming a substantially circular C-shaped hook with a frontal opening of substantially less than 180 degrees measured from an axis of the hook, said opening located between spaced ends of said jaws; and
a single laterally extending notch on the inside surface of said upper jaw proximate said frontal opening.

2. The device of claim 1 wherein said jaws have a continuous arcuate inside surface except for said notch.

3. The device of claim 2 wherein said base further includes orientation marks on the bottom planar surface thereof proximate only one of said front or rear sides.

4. The device of claim 1 wherein said panel attachment means are deformer undercut grooves for receiving the cold flow of metal from a panel attached thereby.

6. The device of claim 1 further including an insert which encompasses the inside surface of the jaws and partially encompasses the lateral sides of the fastener adjacent the lateral opening.

7. The device of claim 6 wherein the insert covers the edges of the jaws.

8. The device of claim 7 wherein said insert further includes a pivotable flap that lies across the frontal opening to positively retain items held within the hook.

9. The device of claim 8 wherein the flap is unitary with said insert and resiliently biased toward a closed position.

10. The device of claim 1 further including a spring-biased catch which covers the frontal opening of the fastener to positively retain items held within the hook.

11. The device of claim 10 wherein said insert includes two opposing ears which have inward-facing dimples that engage cooperating recesses on opposite sides of the lower jaw to provide a pivot for said catch.

12. The device of claim 111 wherein said insert includes a tail portion which is free to slide against the inside surface of the lower jaw to provide a spring force to close said catch.

13. The device of claim 12 wherein said insert is composed of metal.

14. The device of claim 12 wherein said insert is composed of an electrically non-conductive thermoplastic.

15. The device of claim 6 further described in that said insert is a continuous cylinder covering said frontal opening.

16. A cable hook having self-clinching attachment means, comprising:
a substantially rectangular base having a planar bottom surface and further including panel attachment means located on opposing front and rear side surfaces thereof;
a hook portion extending upwardly from said base, said hook portion including upper and lower jaws forming a substantially C-shaped hook with a frontal opening located between spaced ends of said jaws;
a single laterally extending notch on the inside surface of said upper jaw proximate said frontal opening; and
said base further including orientation marks on the bottom planar surface thereof proximate only one of said front or rear sides.
